(19) United States
(12) Patent Application Publication
(10) Pub. No.: US 2024/0199840 A1
(43) Pub. Date: Jun. 20, 2024

(54) Method For The Production Of A Polyhydric Alcohol From A Urethane Containing Polymer

(71) Applicant: Ioniqa Technologies B.V., Eindhoven (NL)

(72) Inventors: Luuk Lambertus Christina Olijve, Eindhoven (NL); Andre Banier DE HAAN, Eindhoven (NL); Joost Robert WOLTERS, Eindhoven (NL)

(73) Assignee: Ioniqa Technologies B.V., Eindhoven (NL)

(21) Appl. No.: 18/286,834

(22) PCT Filed: Apr. 14, 2022
(86) PCT No.: PCT/NL2022/050207

§ 371 Date: Oct. 13, 2023

(30) Foreign Application Priority Data
Apr. 16, 2021 (NL) 2028002

(51) Int. Cl. C08J 11/24; B01J 23/02; B01J 23/06; B01J 23/745; B01J 31/20; B01J 35/33; B01J 35/45; B01J 35/61; C08G 65/08; C08G 65/30

(52) U.S. Cl. CPC C08J 11/24; B01J 23/02; B01J 23/06; B01J 23/745; B01J 31/20; B01J 35/33; B01J 35/45; B01J 35/612; C08G 65/08; C08G 65/30; B01J 2231/005; B01J 2531/842; C08J 2375/08

(57) ABSTRACT

A method is described for the production of a polyhydric alcohol from a urethane containing polymer. The method first provides a reaction mixture comprising said polymer, a solvent, which comprises a polyol capable of reacting with said polymer to depolymerize said polymer; and a catalyst, which comprises catalyst particles. Said polymer is depolymerized in said reaction mixture by reacting with said polyol to produce said polyhydric alcohol. A further step allows said reaction mixture containing said polyhydric alcohol product to separate into an, upper, product phase containing said polyhydric alcohol and another, lower, phase mainly containing said polyol and said catalyst. The catalyst is recovered from said another phase, while said polyhydric alcohol product is recovered from said product phase.

### FIELD OF THE INVENTION

The present invention relates to a method for the production of a polyhydric alcohol from a urethane containing polymer. Said urethane containing polymer is a homopolymer or copolymer containing a urethane structural unit.

### BACKGROUND OF THE INVENTION

There is an increasing awareness that the large amount of polymers used nowadays for a variety of purposes should be recycled in order to prevent an increasing amount of polymer waste. Incineration is one possibility, however undesirable for obvious reasons. Mechanical shredding and milling of used polymers may be another solution to the problem of accumulating polymer waste. However, the recycled polymer properties are then degraded and they frequently end up as filler for other materials. Circular recycling (chemical recycling) is clearly the solution of choice. In circular recycling, the polymer to be recycled is depolymerized into its building blocks, such as the repeating units from which the polymer is made. The repeating units resulting from the degradation reaction may be used again in making a new polymer.

Degradation of used polymers may be hindered by the fact that such polymers are typically present in a product that may contain a plurality of materials, and suitable separation methods should be provided for separating the polymer to be recycled from the product. As a consequence a significant amount of used polymers is still used as a fuel, which is burned.

A further difficulty seems to be assuring a consistent and continuous waste sourcing, such as fibers, films, bottles, foams and textiles for instance, in a required extensive amount at one single site. Yet a further issue may be that, even when the problem of separation of the desired polymer to be recycled from a product has been solved satisfactorily, the process of degradation of the polymer into smaller repeating units, such as its repeating units, has proven to be difficult. Many known methods are not selective enough, or are deficient in terms of a too low conversion. An efficient conversion of the polymers to the desired products (repeating units and/or oligomers) is desirable, at the same time minimizing production of waste in terms of side products. In other words, a relatively high yield (selectivity times conversion) is a desirable goal in depolymerization methods.

Polyurethane homo- and copolymers are widely used nowadays. They are typically used into a variety of intermediate articles such as foams, chips, films, and/or end products such as fabrics, insulation articles and foam articles. The processing of polyurethane (co)polymers into intermediate articles and end products results in a huge amount of polyurethane processing waste.

PU foam typically consists of from 30-40 wt. % of diisocyanate, such as toluene diisocyanate (TDI), and from 60-70 wt. % of a polyhydric alcohol. The specific combination of the diisocyanate/polyhydric alcohol and the polyhydric alcohol properties largely determine the polyurethane (PU) foam properties. Currently, mechanical recycling of PU foam is mainly used in applications such as bonded foam or in downcycling of insulation material. A linear chemical recycling method is also known. In such a linear recycling method, as disclosed in U.S. Pat. No. 5,300,530 5,357,006 for instance, a glycolysis is performed and the reaction mixture is further processed by propoxylation or by adding glycidyl ether to reduce in particular OH number and toxic aromatic amine by-products. In general, a “dark colored viscous fluid” polyhydric alcohol recyclate is obtained from the linear approach, and the product is not equal to ‘virgin’ polyhydric alcohol. It is therefore used for other less demanding applications such as lower-grade products and rigid foams. In addition to the brown color typically obtained and the undesirable presence of toxic aromatic diamines, residual catalyst and/or other metal/salts and/or glycol may remain in the polyhydric alcohol, which can affect foaming properties. The polyhydric alcohol recyclate has a (too) high viscosity for satisfactory further processing.

Circular recycling methods, such as disclosed in U.S. Pat. No. 5,605,935, have also been attempted for polyurethane. Such methods aim at depolymerizing waste polyurethane materials back to the polyhydric alcohol monomer, which polyhydric alcohol monomer is equal or similar to virgin polyhydric alcohol and may then be reused in forming polyurethane again by polymerization. Preferably, the polyurethane has properties similar to virgin polyurethane materials, such that it may be used in flexible (soft) foam products for instance.

In general, polyurethane is depolymerized at elevated temperatures, usually in the presence of a homogeneous catalyst. Although the polyhydric alcohol yield of the known process is acceptable, there is a need in the industry for an improved method for the depolymerization of polyurethane processing waste.

Therefore, it is an aim of the present invention to provide a circular recycling method for waste polyurethane products at satisfactory yield. A further aim is to provide a recovered polyhydric alcohol that has a demonstrated polyhydric alcohol quality almost equal or equal to virgin polyhydric alcohol. This allows the recovered polyhydric alcohol to be used in producing flexible foam products for instance that cannot be distinguished from virgin products. Obviously, the recovered polyhydric alcohol may also be used for producing down-cycled products such as rigid foam.

### SUMMARY OF THE INVENTION

The invention thereto provides a method in accordance with claim 1. A method for the production of a polyhydric alcohol from a urethane containing polymer is provided that comprises the steps of:
a. providing a reaction mixture comprising:
   i. said polymer, which comprises a urethane structural unit;
   ii. a solvent, which comprises a polyol capable of reacting with said polymer to depolymerize said polymer; and
   iii. a catalyst, which comprises catalyst particles;
   wherein a weight ratio of said polyol to said urethane containing polymer is from 3 to 50;
b. depolymerizing said polymer in said reaction mixture by reacting with said polyol to produce said polyhydric alcohol;
c. allowing said reaction mixture containing said polyhydric alcohol product to separate into an, upper, product phase containing said polyhydric alcohol and another, lower, phase mainly containing said polyol and said catalyst;
d. recovering the catalyst from said another phase; and
e. recovering said polyhydric alcohol product from said product phase.

The prior art method uses homogeneous catalysts such as small amounts of a tertiary amine or tin carboxylate to depolymerize the polyurethane. The waste polyurethane is recycled into polyhydric alcohols by a glycolysis reaction. The polyurethane, for instance in the form of a foam, is typically provided into relatively small particles and mixed with a glycol or a mixture of glycols, such as propylene glycol, dipropylene glycol, diethylene glycol and the like. The glycolysis is carried out at high temperatures, for instance at temperatures of between 180° C. and 220° C., where the foam is rapidly dissolved into the liquid reaction mixture. Urethane links between the isocyanate and the polyhydric alcohol are attacked by the glycol. Also, a transurethanation may occur that re-establishes a polyurethane bond with the glycol and liberates the original polyhydric alcohol. Polyurethane with reduced molecular weight is hereby obtained. The urethane and possibly also urea bonds may be attacked by the glycol to form a urethane with the glycol and an amine. In TDI or methylenediphenyl diisocyanate (MDI) based polyurethanes, the amines liberated comprise primarily oligomeric aromatic amines. Also, some free diamines may be formed depending on the polyurethane product and process conditions.

The method in accordance with the invention at least partly avoids disadvantages of the known method. It provides a circular recycling process and yields a recovered polyhydric alcohol of almost equal or equal quality as virgin polyhydric alcohol. The invented method in short proposes a so-called split-phase glycolysis using a solvent, which comprises a polyol capable of reacting with said polymer to depolymerize said polymer and a catalyst comprising catalyst particles. Providing the reaction mixture preferably comprises dissolving the polyurethane in the solvent of the reaction mixture.

The invented method, and in particular the claimed polyol to urethane containing polymer weight ratio of at least 3, not only allows adding the urethane containing polymer much faster, for instance in two or three portions, but may also increase the yield.

After glycolysis, the reaction mixture is separated into a non-polar upper phase (hydrophobic polyhydric alcohol) and a polar lower phase (solvent, catalyst and byproducts). The split-phase process has turned out to be specific to more than 80% polyether-based polyhydric alcohols, such as propylene oxide (PPO)-based polyhydric alcohol.

The invented method distinguishes from known methods in at least one of: (1) the type of heterogeneous catalyst used and its optional magnetic recovery; (2) the type of polyol reactant; (3) the polyurethane/polyol reactant ratio used, for instance 10:30; and (4) the optional purification step, performed in an embodiment by adding methyl-tert-butylether (MTBE) co-solvent to the recovered polyhydric alcohol and extraction with a 50/50 vol % mixture of 0.1 M hydrogen chloride (HCl) in water and polyol, for instance ethylene glycol (EG).

The invented method yields an improved quality recovered polyhydric alcohol product. Relevant specifications for recovered polyhydric alcohol among others comprise:
Color (should be colorless, “water-white”)
OH number (hydroxyl functionality, chain length, residue glycol; affects foam properties)
Acidity (influences the OH number determination)
Brookfield viscosity
Water content (influences foam behavior)
Trace metals (Na, K, Ca, Sn, etc., influences foaming behavior)
Smell (produced foam must not contain a strong solvent smell, or harmful VOCs)

The polyhydric alcohol recovered from the invented method performs particularly well with regard to the above specifications, as will be apparent from the experimental disclosure given further below.

According to an embodiment of the invention, a method is provided wherein said polyol capable of reacting with said polymer is selected from the group consisting of ethylene glycol, diethylene glycol and glycerol.

The weight ratio of polyol to urethane containing polymer may be chosen according to the reaction conditions and the properties of the urethane containing polymer and the polyol. Preferred embodiments relate to methods wherein a weight ratio of said polyol to said urethane containing polymer is from 5 to 50, preferably from 10 to 45, more preferably from 10 to 30, and most preferably from 20 to 40.

In other embodiments, methods are provided wherein a molar ratio of said polyol to said urethane structural unit of the polymer is from 3 to 20, preferably from 5 to 15, more preferably from 10 to 12.

In yet other embodiments of the invention, methods are provided, wherein said separating step c. comprises adding a co-solvent to the reaction mixture, wherein said co-solvent has a relative polarity lower than the relative polarity of the polyol reacting solvent.

The relative polarity of the co-solvent is preferably at most 0.2, preferably is in the range of 0.1-0.2. Relative polarity is defined against the polarity of water of which the relative polarity is 1. The values for the relative polarity are normalized from measurements of solvent shifts of absorption spectra and were extracted from Christian Reichardt, Solvents and Solvent Effects in Organic Chemistry, Wiley-VCH Publishers, 3rd ed., 2003. Suitable co-solvents comprise ethyl tert-butyl ether (ETBE) and other tert-butyl ether types, with a relative polarity around 0.1-0.2. The preferred methyl tert-butyl ether (MTBE) has a relative polarity of 0.124. The tert-butyl group may prevent the formation of (potentially explosive) peroxides. Suitable co-solvents may also comprise diethyl ether and other alkyl/aryl ethers; halogens such as chloroform, chlorobenzene, although less desirable; aromatics such as benzene, toluene, xylene, although some may be objectionable due to being restricted substances/carcinogenic; hydrocarbons such as pentane; esters such as ethyl acetate (EtOAc), ethyl benzoate and other non-polar esters, although esters may hydrolyse in acidic environments; ketones such as methyl isobutyl ketone (MIBK), 2-pentanone and cyclohexanone; and alcohols such as 1-butanol, tert-butyl alcohol, pentanol or cyclohexanol. The latter generally have a relatively high polarity and may be less desirable due to their relatively high boiling point. Particularly preferred co-solvents comprise green alternatives for methyl-tert-butylether (MTBE), such as 2-methyltetrahydrofuran or cyclopentyl methyl ether for instance.

In yet other embodiments of the method, the recovering step of the polyhydric alcohol product comprises extracting the polyhydric alcohol product from the upper product phase using an extracting solvent mixture comprising ethylene glycol and a water phase.

The volume ratio of said ethylene glycol to said water phase is preferably 10:90 to 90:10, and more preferably 25:75 to 75:25.

In a particularly preferred method, the water phase contains hydrogen chloride (HCl), preferably in a molar amount of at least 0.05 M, in particular in a molar amount of at most 1.00 M.

According to embodiments of the invented method, the depolymerizing step comprises maintaining the water amount in the reaction mixture below 3 wt %, preferably below 2 wt %, with respect to the total weight of the solvent. It has been found that by maintaining the water amount in the reaction mixture during the depolymerizing step below 3 wt %, preferably below 2 wt %, the amount of side-products, such as diamines, is reduced, in particular the amount of side-products which have a strong colour may be reduced.

The reaction temperature of the depolymerization may be chosen dependent on the type of polyurethane product and solvent. In preferred embodiments, a method is claimed wherein reaction conditions of the depolymerizing step comprise a temperature in a range of 150 to 300° C., preferably 190 to 250° C., more preferably 190 to 210° C.

Another preferred method according to an embodiment uses a depolymerizing step that comprises refluxing the solvent at a reflux temperature of the solvent. The solvent is preferably selected to have a reflux temperature in a range of 190 to 250° C., more preferably of 195 to 210° C. The refluxing process supports maintaining the temperature substantially constant and at the same time maintaining the water amount in the reaction mixture low.

The invention may be carried out using any heterogeneous catalyst suitable for the purpose. In a depolymerization method according to an embodiment, the catalyst forms a dispersion in the reaction mixture during step a. of the method.

Preferred heterogeneous catalysts used in the method comprise a metal composition, i.e. a pure metal or a metal alloy. More preferably, the heterogeneous catalyst comprises a metal containing particle. The catalyst particles are preferably used as such, i.e. without having any other reactive groups or moieties attached to its surface. However, the surface may be oxidized.

One class of suitable heterogeneous catalysts comprises metal particles that are able to catalyze a transesterification reaction. Suitable metals include but are not limited to magnesium (Mg), titanium (Ti), zirconium (Zr), manganese (Mn), iron (Fe), cobalt (Co), zinc (Zn), aluminum (Al), germanium (Ge) and antimony (Sb), as well as their oxides, and further alloys thereof. Also suitable are nickel (Ni) and precious metals, such as palladium (Pd) and platinum (Pt). Ni has the advantage of being ferromagnetic, such that it may form optimal magnetic properties for recovery when combined with another metal such as Fe.

The metal particle may be provided with an oxide surface, which may further enhance catalysis. The oxide surface may be formed by itself, in contact with air, in contact with water, or the oxide surface may be applied deliberately.

Another subclass of suitable heterogeneous catalysts comprises transition metal particles. A possible mechanism, without being bound thereto, may be that the metal particles catalyze the rate-limiting step in the depolymerization reaction, which turns out to be the release of individual molecules of the urethane containing polymer out of the polymer, which is for instance semi-crystalline. This release results in dispersing of urethane containing polymer material into the reactive solvent and/or dissolving of individual urethane containing polymer molecules in the reactive solvent. Such dispersing and/or dissolving is believed to further enhance depolymerization from polymer into monomers and oligomers.

Further, a surface layer of the transition metal particles, preferably oxidized, may get dissolved into the reactive solvent. The resulting metal ions, for instance Fe2+ and/or Fe3+ may well be active in the catalysis. The transition metal may be chosen from the first series of transition metals, also known as the 3d orbital transition metals. More particularly, the transition metal is chosen from iron (Fe), nickel (Ni) and cobalt (Co).

Since cobalt however is not healthy and iron and nickel particles may be formed in pure form, iron and nickel particles are most preferred. Furthermore, use can be made of alloys.

Most preferred is the use of iron particles. Iron particles have been found to catalyze the depolymerization of polyurethane containing polymer for instance to conversion rates into monomer of 70-90% within an acceptable reaction time of at most 6 hours. The needed concentration of catalyst is 1wt % relative to the amount of urethane containing polymer or less. Good results also have been achieved with a catalyst loading below 0.2 wt % and even below 0.1 wt %. Such a low loading of the catalyst is highly beneficial, and the invented method allows to recovering an increased amount of the nanoparticle catalyst.

In one suitable embodiment, use is made of metal particles in the range of 0.5-150 μm. The size range herein defines the average diameter. The average diameter is herein measured by means of electron microscopy. Particles in this size range are sufficiently large to be separated from the product solution by means of a conventional separation technology such as filtering or a centrifuge treatment. At the same time, they are sufficiently small to obtain a good distribution of the particles and to allow that the particle surface may get close to the solid polyurethane polymer, resulting in highly effective catalysis. A preferred particle size is from 0.5-100 μm, more preferably from 1-50 μm, and most preferably from 1-10 μm for some embodiments.

Advantageously, the metal or metal oxide particles, such as nickel particles, iron particles. ZnO and MgO particles, have a low surface area and are substantially non-porous. Suitably, the surface area is less than 3 m²/g, preferably at most 1m²/g or even less than 0.6 m²/g. The porosity is suitably less than 10⁻² cm³/g or even less for instance at most 10⁻³ cm³/g.

It has been found that such non-porous transition metal particles can be suitably prepared by thermal decomposition of carbonyl complexes such as iron pentacarbonyl and nickel tetracarbonyl. The inventors have understood that a non-porous particle tends to be more suitable than a porous particle, since its exposure to the alcohol is less, and therefore, the corrosion of the particle is less and the particle can be reused more often for catalysis. Furthermore, due to the limited surface area, any oxidation at the surface results in a low quantity of metal-ions and therewith a low level of ions that are present in the product stream as a contaminant to be removed therefrom.

Recently, quite some attention has been paid to nanoparticles as a depolymerization catalyst. Such nanoparticles have a small diameter and therewith a high surface area, for instance of 10-1000 m²/g, more preferably of 50-500 m²/g, and most preferably from 80-150 m²/g. This high surface area allows for significant adsorption of the urethane containing polymer, which is believed to result is quick depolymerization and therewith an economically feasible process. While the use of magnetic nanoparticles principally allows separation by means of magnetic attraction, many nanoparticles are so small that they may not be attracted sufficiently. One option to solve this problem is the generation of larger-sized clusters of nanoparticles.

The present catalyst particle is preferably of a magnetic nature, either comprising a magnetic material, or having the ability to be magnetized sufficiently under relatively modest magnetic fields, such as being applied in the present method. Suitably, the magnetic particles contain an oxide of iron, manganese and/or cobalt, or combinations thereof. Iron oxide, for instance but not exclusively in the form of Fe₃O₄ is preferred. Another suitable example is CoFe₂O₄.

It has been found that the nanoparticles are preferably sufficiently small to function as a catalyst, therewith degrading the polyurethane into smaller units, wherein the yield of these smaller units, and specifically the monomers thereof, is high enough for commercial reasons. It has further been found that the nanoparticles should be sufficiently large in order to be able to reuse the present complex by recovering the present catalyst complex. It is economically unfavorable that the catalyst complex would be removed with either waste or degradation product obtained. Suitable nanoparticles have an average diameter of 2-500 nm. It is preferred to use nanoparticles comprising iron oxide.

The, preferably magnetic, nanoparticles may have an average diameter of 2 nm-500 nm, preferably from 3 nm-100 nm, more preferably from 4 nm-50 nm, such as from 5-10 nm. It has been found that e.g. in terms of yield and recovery of catalyst complex a rather small size of particles of 5-10 nm is optimal. It is noted that the term “size” relates to an average diameter of the particles, wherein an actual diameter of a particle may vary somewhat due to characteristics thereof. In addition aggregates of nanoparticles may be formed e.g. in the solution. These aggregates typically have sizes in a range of 50-200 nm, such as 80-150 nm, e.g. around 100 nm.

Nanoparticle sizes and a distribution thereof can be measured by light scattering, for instance using a Malvern Dynamic light Scattering apparatus, such as a NS500 series. In a more laborious way, typically applied for smaller particle sizes and equally well applicable to large sizes representative electron microscopy pictures are taken and the sizes of individual particles are measured on the picture. For an average particle size, a number weight average may be taken. In an approximation the average may be taken as the size with the highest number of particles or as a median size.

The particles may comprise one or substantially one (chemical) element, such as iron, cobalt, manganese, etc., but may also comprise particles having a metal ion and a counter ion, such as oxygen, boron and nitrogen. Also combinations, such as alloys, mixed particles, and the like are applicable. In a preferred method, the catalyst particles comprise a transition metal oxide, preferably an iron oxide, more preferably a ferrite such as hematite (Fe₂O₃), magnetite (Fe₃O₄), and maghemite (Fe₂O₃, γ-Fe₂O₃).

The surface area of the catalyst nanoparticles is preferably more than 3 m²/g.

The catalyst is in preferred embodiments used in a ratio of 0.1-20 wt. %, preferably 0.5 5 wt. %, relative to the polymer weight.

### DETAILED DESCRIPTION OF PREFERRED EMBODIMENTS

The following examples illustrate various preferred embodiments of the invention. Comparative Experiments are carried out according to the state of the art.

### Examples 1-4 and Comparative Experiments A-C

### Comparative Experiment A

A 500 mL round bottom flask (RBF) was charged with 10,751 g dipropylene glycol and 0.21 g dibutyltin dilaurate (DBTDL) catalyst. The RBF was placed in a reflux set-up equipped with a condenser, overhead stirrer and an oil bath and heated to 200° C. under argon atmosphere. An amount of 10,043 gram of flexible PU foam pieces (1-2 cm³) based on polyether polyhydric alcohol with a PPO content of 88% was added and the mixing speed set to 80 RPM. After 5h of reaction time, the reaction mixture was cooled down and collected. The resulting product was a highly viscous, dark-brown paste.

### Comparative Experiment B

A 500 mL round bottom flask (RBF) was charged with 10.739 g diethylene glycol and 0,008 g TI(IV)BuO catalyst. The RBF was placed in a reflux set-up equipped with a condenser, overhead stirrer and an oil bath and heated to 200° C. under argon atmosphere. An amount of 10,053 gram of flexible PU foam pieces (1-2 cm³) based on polyether polyhydric alcohol with a PPO content of 88% was added and the mixing speed set to 80 RPM. After 5h of reaction time, the reaction mixture was cooled down and collected. The resulting product was a highly viscous, dark-brown paste.

### Comparative Example C

A 500 mL round bottom flask (RBF) was charged with 10,435 g tripropylene glycol and 0,101 g Na₂O catalyst. The RBF was placed in a reflux set-up equipped with a condenser, overhead stirrer and an oil bath and heated to 200 degrees C. under argon atmosphere. An amount of 10,162 gram of flexible PU foam pieces (1-2 cm³) based on polyether polyhydric alcohol with a PPO content of 88% was added and the mixing speed set to 80 RPM. After 5h of reaction time, small pieces of unreacted PU foam were still visible. The reaction mixture was cooled down and the resulting product was collected as a high viscous, non-transparent, brown paste.

### Comparative Example D

A 500 mL round bottom flask (RBF) was charged with 14.059 g ethylene glycol and 1.023 g of carbonyl iron catalyst. The RBF was placed in a reflux set-up equipped with a condenser, overhead stirrer and an oil bath and heated to 2(X) degrees C. under argon atmosphere. An amount of 10.019 g of flexible PU foam pieces (1-2 cm3) based on polyether polyhydric alcohol with a PPO content of 88% was added in two portions via the side necks and the mixing speed set to 80 RPM. After 5h of reaction time, small pieces of unreacted PU foam were still visible. The reaction mixture was cooled down and the resulting product was collected as a high viscous, non-transparent, brown paste.

The results of the Comp Ex A-D are shown in Table 1A and Table 1B.

### Example 1: Fe₃a

A 1000 mL round bottom flask (RBF) was charged with 120.4 g ethylene glycol and 0,838 g of Fe₃O₄ catalyst. The RBF was placed in a reflux set-up equipped with a condenser, overhead stirrer and heating mantle and heated to reflux temperature (197 degrees C.) under argon atmosphere. An amount of 39.9 gram of flexible PU foam pieces (1-2 cm³) based on polyether polyhydric alcohol with a PPO content of 88% was added in two portions via the side necks and the mixing speed set to 80 RPM. After 5h of reaction time, the reaction mixture was cooled down. An amount of 120 mL of MTBE is added to the reaction flask and the mixture is transferred to a 1000 mL separation funnel. The mixture is extracted and left overnight to phase separate. The glycol layer is discarded and the organic layer is extracted with 120 mL of 50/50 vol % 0.1 M HCl/EG. The water/EG layer is discarded and the organic layer is dried over MgSO₄, filtered and dried in vacuo to recover the purified polyhydric alcohol as a light yellow-brown, transparent viscous oil (16.063 g, 40.3%).

### Example 2: Carbonyl Iron

A 1000 mL round bottom flask (RBF) was charged with 119.9 g ethylene glycol and 0,884 g of carbonyl iron catalyst. The RBF was placed in a reflux set-up equipped with a condenser, overhead stirrer and heating mantle and heated to reflux temperature (197 degrees C.) under argon atmosphere. An amount of 39.9 gram of flexible PU foam pieces (1-2 cm³) based on polyether polyhydric alcohol with a PPO content of 88% was added in two portions via the side necks and the mixing speed set to 80 RPM. After 5h of reaction time, the reaction mixture was cooled down. An amount of 120 mL of MTBE is added to the reaction flask and the mixture is transferred to a 1000 mL separation funnel. The mixture is extracted and left overnight to phase separate. The glycol layer is discarded and the organic layer is extracted with 120 mL of 50/50 vol % 0.1 M HCl/EG. The water/EG layer is discarded and the organic layer is dried over MgSO₄, filtered and dried in vacuo to recover the purified polyhydric alcohol as a light yellow-brown, transparent viscous oil (19,127 g, 47.9%).

### Example 3: MgO

A 1000 mL round bottom flask (RBF) was charged with 120.6 g ethylene glycol and 0.848 g of MgO catalyst. The RBF was placed in a reflux set-up equipped with a condenser, overhead stiffer and heating mantle and heated to reflux temperature (197 degrees C.) under argon atmosphere. An amount of 40.0 gram of flexible PU foam pieces (1-2 cm³) based on polyether polyhydric alcohol with a PPO content of 88% was added in two portions via the side necks and the mixing speed set to 80 RPM. After 5h of reaction time, the reaction mixture was cooled down. An amount of 120 mL of MTBE is added to the reaction flask and the mixture is transferred to a 1000 mL separation funnel. The mixture is extracted and left overnight to phase separate. The glycol layer is discarded and the organic layer is extracted with 120 mL of 50/50 vol % 0.1 M HCl/EG. The water/EG layer is discarded and the organic layer is dried over MgSO₄, filtered and dried in vacuo to recover the purified polyhydric alcohol as a light yellow-brown, transparent viscous oil (19,423 g, 48.3%).

### Example 4: ZnO

A 1000 mL round bottom flask (RBF) was charged with 120.6 g ethylene glycol and 0.846 g of ZnO catalyst. The RBF was placed in a reflux set-up equipped with a condenser, overhead stirrer and heating mantle and heated to reflux temperature (197 degrees C.) under argon atmosphere. An amount of 40.1 gram of flexible PU foam pieces (1-2 cm³) based on polyether polyhydric alcohol with a PPO content of 88% was added in two portions via the side necks and the mixing speed set to 80 RPM. After 5h of reaction time, the reaction mixture was cooled down. An amount of 120 mL of MTBE is added to the reaction flask and the mixture is transferred to a 1000 mL separation funnel. The mixture is extracted and left overnight to phase separate. The glycol layer is discarded and the organic layer is extracted with 120 mL of 50/50 vol % 0.1 M HCl/EG. The water/EG layer is discarded and the organic layer is dried over MgSO₄, filtered and dried in vacuo to recover the purified polyhydric alcohol as a light yellow-brown, transparent viscous oil (18,838 g, 47.0%).

The results of Ex 1-4 are shown in Table 1A and Table 1B.

TABLE 1A
properties of polyhydric alcohol products

| | OH-value | Acidity | Water |
|---|---|---|---|
| | (mg KOH/g) | (mg KOH/g) | content (%) |
| ISO/ASTM | D4274 | D4662 | |
| Preferred for flexible | 28-160 | <0.1 | <0.1 |
| PU foam | | | |
| Comp example A | ND | ND | ND |
| Comp example B | ND | ND | ND |
| Comp example C | ND | ND | ND |
| Comp example D | ND | ND | ND |
| Example 1 | 116.3 ± 0.7 | 0.61 ± 0.07 | 0.22 |
| Example 2 | 114.6 ± 3.2 | 0.22 ± 0.00 | 0.14 |
| Example 3 | 121.5 ± 1.3 | 0.37 ± 0.07 | 0.06 |
| Example 4 | 115.3 ± 2.6 | 0.39 ± 0.00 | 0.06 |

TABLE 1B
properties of polyhydric alcohol products

| | Trace metals XRF (ppm) | | | | | | |
|---|---|---|---|---|---|---|---|
| | Sn | Ca | Ti | Fe | Mg | Zn | Si |
| ISO/ASTM | NA | NA | NA | NA | NA | NA | NA |
| Preferred for | No heavy metals | | | | | | |
| flexible PU foam | | | | | | | |
| Comp example A | 2119 | 596 | 0.7 | 19 | ND | ND | ND |
| Comp example B | 356 | 109 | 44 | 21 | ND | ND | 1002 |
| Comp example C | 242 | 70.7 | <0.3 | 18.3 | 30.9 | 6.4 | 217 |
| Comp example D | ND | ND | ND | ND | ND | ND | ND |
| Example 1 | <0.3 | <0.8 | <0.3 | <0.2 | <10.0 | <0.5 | 792 |
| Example 2 | <0.3 | <0.8 | <0.3 | <2.0 | <10.0 | <0.5 | 690 |
| Example 3 | <0.3 | <0.8 | <0.3 | <2.0 | <10.0 | <0.5 | 880 |
| Example 4 | <0.3 | 26.5 | <0.3 | <2.0 | 10.2 | <0.5 | 724 |

The results in terms of specifications such as polyhydric alcohol (PH) yield, acidity and OH-value are shown in Table 1. Table 1A includes the ISO/ASTM norm used to measure the specification parameters. The table also indicates a referred polyhydric alcohol range for the parameters.

The most important trace metals for Comp Ex A were Sn (2119 ppm), Ca (596 ppm) and Fe (19 ppm), those for Comp Ex B were Si (1002 ppm), Sn (356 ppm), Ca (109 ppm), Ti (44 ppm) and Fe (21 ppm) and those for Comp Ex C were Si (218 ppm), Sn (243 ppm), Ca (70 ppm), Mg (31 ppm) and Fe (18 ppm).

For Example 1-Example 4, the most important trace metals were reduced, which resulted in a substantially lower amount of trace metals for a polyhydric alcohol recovered according to the invention. The yield for Example 1-Example 3 was in a range 60-75%, based on the total polyol content. The (much lower) yields for Comp Ex A, B and C could not be measured since too much residual remained in the flask.

### Purification Process Step

Purification of crude polyhydric alcohol of the organic layer was carried out via liquid-liquid extraction.

A depolymerization was done according to Example 1. After discarding the glycol fraction, the organic layer containing crude polyhydric alcohol and methyl-tert-butylether (MTBE) solvent was used for liquid-liquid extraction tests, with the following water and glycol solvent mixtures, respectively, as shown in Table 2:

TABLE 2
extraction tests for organic layer containing crude polyhydric
alcohol and methyl-tert-butylether (MTBE) solvent

| Extraction | | |
|---|---|---|
| test | Extraction liquid | Extraction result |
| 1 | 50/50 vol % | immediately two layers with a clear |
| | 0.1M HCl/EG | interface and a transparent top and |
| | | bottom layer. The bottom layer was |
| | | dark-red coloured while the organic |
| | | top layer was non-coloured. |
| 2 | EG | turbid organic top layer and it took |
| | | over 2 days to form two layers. |
| 3 | 50/50 vol % | yellow-coloured organic top layer. |
| | water/EG | |
| 4 | Demiwater | a turbid mixture. Leaving the mixture |
| | | over 2 days did not result in de- |
| | | emulsification and the organic top layer |
| | | remained turbid. |
| 5 | Demiwater adjusted | a turbid mixture. Leaving the mixture |
| | to pH 4-5 using HCl | over 2 days did not result in de- |
| | | emulsification and the organic top layer |
| | | remained turbid |
| 6 | Saturated NaCl | a yellow-coloured organic top layer |
| | solution | |
| 7 | 50/50 vol % 0.1M | a coloured and turbid organic top layer. |
| | HCl/saturated | After over 2 days, there was still |
| | NaCl solution | emulsification visible at the interface |
| 8 | 0.1M HCl | a turbid solution. After over 2 days, |
| | | there was still emulsification visible at |
| | | the interface. |

From the above results it is clear that the test (1) based on 50/50 vol % 0.1 M HCl/EG produced good and fast extraction of coloured side-products from the organic layer containing the polyhydric alcohol product.

A substantially pure and substantially non-colored polyhydric alcohol product may be obtained from these extraction conditions, which is usable as recovered polyhydric alcohol that has a demonstrated polyhydric alcohol quality almost equal or equal to virgin polyhydric alcohol.

From the above description, one skilled in the art can easily ascertain the essential characteristics of this invention, and may make changes and modifications to the disclosed embodiments without departing from the spirit and scope thereof, as claimed in the appended claims.

1. A method for the production of a polyhydric alcohol from a urethane containing polymer, said method comprising the steps of:
a. providing a reaction mixture comprising:
i. said polymer, which comprises a urethane structural unit;
ii. a solvent, which comprises a polyol capable of reacting with said polymer to depolymerize said polymer; and
iii. a catalyst, which comprises catalyst particles;
wherein a weight ratio of said polyol to said urethane containing polymer is from 3 to 50;
a. depolymerizing said polymer in said reaction mixture by reacting with said polyol to produce said polyhydric alcohol;
b. allowing said reaction mixture containing said polyhydric alcohol product to separate into an, upper, product phase containing said polyhydric alcohol and another, lower, phase mainly containing said polyol and said catalyst;
c. recovering the catalyst from said another phase; and
d. recovering said polyhydric alcohol product from said product phase.

2. Method as claimed in claim 1, wherein said polyol is selected from the group consisting of ethylene glycol, diethylene glycol and glycerol.

3. Method as claimed in claim 1, wherein a weight ratio of said polyol to said urethane containing polymer is from 5 to 50.

4. Method as claimed in any one of the preceding claims claim 1, wherein a molar ratio of said polyol to said urethane structural unit of the polymer is from 3 to 20.

5. Method as claimed in claim 1, wherein said separating step c. comprises adding a co-solvent to the reaction mixture, wherein said co-solvent has a relative polarity lower than the polarity of the polyol reacting solvent.

6. Method as claimed in claim 5, wherein the relative polarity of the co-solvent is at most 0.2.

7. Method as claimed in claim 1, wherein the recovering step of the polyhydric alcohol product comprises extracting the polyhydric alcohol product from the upper product phase using an extracting solvent mixture comprising ethylene glycol and a water phase.

8. Method as claimed in claim 7, wherein a volume ratio of said ethylene glycol to said water phase is 10:90 to 90:10.

9. Method as claimed in claim 8, wherein the water phase contains HCl.

10. Method as claimed in claim 1, wherein the depolymerizing step comprises maintaining the water amount in the reaction mixture below 3 wt.

11. Method as claimed in claim 1, wherein reaction conditions of the depolymerizing step comprise a temperature in a range of 150 to 300° C.

12. Method as claimed in claim 1, wherein the depolymerizing step comprises refluxing the solvent at a reflux temperature of the solvent.

13. Method as claimed in claim 12, wherein the solvent is selected to have a reflux temperature in a range of 190 to 250° C.

14. Method as claimed in claim 1, wherein the catalyst particles are magnetic particles.

15. Method as claimed in claim 1, wherein the metal particles are selected from those that are able to catalyze a transesterification reaction.

16. Method as claimed in claim 15, wherein the metals include magnesium (Mg), titanium (Ti), zirconium (Zr), manganese (Mn), iron (Fe), cobalt (Co), zinc (Zn), aluminum (Al), germanium (Ge) and antimony (Sb), nickel (Ni), as well as their oxides.

17. Method as claimed in claim 1, wherein the catalyst particles comprise a transition metal oxide.

18. Method as claimed in claim 1 wherein the particle size ranges from 0.5-150 μm.

19. Method as claimed in claim 1, wherein the particles have a surface area of less than 3 m²/g.

20. Method as claimed in claim 1, wherein the catalyst particles comprise nanoparticles having a particle size in the range of 1 nm-50 μm.

21. Method as claimed in claim 20, wherein the catalyst nanoparticles have a surface area of more than 3 m²/g.

22. Method as claimed in claim 1, wherein the catalyst is used in a ratio of 0.1-20 wt %, relative to the polymer weight.

23. Method as claimed in claim 1, wherein said providing step comprises dissolving the polymer in the solvent of the reaction mixture.

24. Method as claimed in claim 1, wherein the polymer is a polymer foam.
